(19) United States
(12) Patent Application Publication
(10) Pub. No.: US 2005/0193173 A1
(43) Pub. Date: Sep. 1, 2005

(54) Methodology, system, and computer-readable medium for collecting data from a computer

(76) Inventors: Sandra E. Ring, Alexandria, VA (US); Eric B. Cole, Leesburg, VA (US)

Correspondence Address: TIMOTHY J MARTIN, PC, 9250 W 5TH AVENUE, SUITE 200, LAKEWOOD, CO, 80226, US

(21) Appl. No.: 10/804,469

(22) Filed: Mar. 18, 2004

Related U.S. Application Data
(62) Division of application No. 10/789,460, filed on Feb. 26, 2004.

(51) Int. Cl. G06F 12/00

(52) U.S. Cl. 711/118

(57) ABSTRACT

A computerized method for collecting suspected data of interest from a computer comprises searching the computer's shot-term memory to locate at least one target memory range containing the suspected data of interest, and copying the suspected data of interest within the target memory range to an alternate data storage location in a manner which avoids writing the suspected data to the computer's long-term memory. Alternatively, the suspected data of interest can be copied to a previously unused data storage location while preserving integrity of non-volatile memory resources. A computer-readable medium and a system for collecting target forensics data are also provided.

### BACKGROUND OF THE INVENTION

The present invention generally concerns the collection of information characteristic of a computer system exploitation, such as surreptitious rootkit installations. To this end, the invention particularly pertains to the field computer forensics.

The continual increase of exploitable software on computer networks has led to an epidemic of malicious activity by hackers and an especially hard challenge for computer security professionals. One of the more difficult and still unsolved problems in computer security involves the detection of exploitation and compromise of the operating system itself. Operating system compromises are particularly problematic because they corrupt the integrity of the very tools that administrators rely on for intruder detection. A rootkit is a common name for a collection of software tools that provides an intruder with concealed access to an exploited computer. Contrary to the implication by their name, rootkits are not used to gain root access. Instead they are responsible for providing the intruder with such capabilities as (1) hiding processes, (2) hiding network connections, and (3) hiding files.

A primary goal of computer forensics is to recover digital crime evidence, such as from a rootkit exploit, for an investigation in a manner which will be admissible in a court of law. These requirements vary depending of venue, but in general the acquisition method must be thoroughly tested with documented error rates and stand up to peer scrutiny. Evidence can be found on long-term storage devices, such as the hard drive (non-volatile memory) and in short-term storage devices, such as RAM (volatile memory). The terms “permanent” and “temporary” are also used to describe such storage types. To protect the condition of the evidence, any technique used must guarantee the integrity or purity of what is recovered. Traditionally, immediately turning off the computer following an incident is recommended to accomplish this in order that a backup be made of the hard drive. Unfortunately all volatile memory is lost when the power is turned off, thus limiting an investigation by destroying all evidence located in volatile memory. However, if a backup to the hard drive is made of the volatile memory prior to shutdown, critical data on the non-volatile memory can be corrupted. A dilemma is thus created since both types of memory can contain significant data which could be vital to the investigation. To date, however, investigators have had to choose collection of volatile or non-volatile memory, thus potentially sacrificing collection of the other. Moreover, investigators have had to make these decisions without the benefit of prior inspection to ascertain which memory bank actually contains the most credible evidence.

Volatile memory contains additional data that can be significant to a case including processes (backdoors, denial of service programs, etc), kernel modifications (rootkits), command line history, copy and paste buffers, and passwords. Accordingly, rootkits are not the only evidence of interest found in volatile memory, since intruders often run several processes on systems that they compromise as well. These processes are generally hidden by the rootkit and are often used for covert communication, denial of service attacks, collection, and as backdoor access. These processes can either reside on disk so they can be restarted following a reboot, or they are located only in memory to prevent collection by standard non-volatile memory forensics techniques. Without this data, the signs of an intruder can disappear with the stroke of the power button. This is why some attackers try to reboot a system after their attack to limit the data that is available to a forensics expert. In addition, intruders sometimes implement “bug out” functions in software that are triggered when an administrator searches for anomalous behavior. These features can do anything from immediately halting a process to more disruptive behaviors such as deleting all files on the hard drive. All of these factors make collection of memory evidence extremely difficult. In order to save the data it must be copied into non-volatile memory, which is usually the hard drive. If this step is not performed correctly it will hinder the investigation rather than aid it.

Although volatile memory unarguably has the potential of containing data significant to cases, the lack of a reliable technique to collect it without disturbing the hard drive has prevented its inclusion in most investigations. For instance, during an incident, evidence could have been written to the hard drive and then deleted. In an effort to be as efficient as possible, operating systems generally mark these areas on a disk as “deleted” but do not bother to actually remove the data that is present. To do so is viewed as a time consuming and unnecessary operation since any new data placed in the space will overwrite the data previously marked as “deleted”. Forensics experts take advantage of this characteristic by using software to recover or “undelete” the data. The deleted information will be preserved as long as nothing is written to the same location on disk. This becomes important to the collection of volatile memory because simply writing it out to the hard drive could potentially overwrite this information and destroy critical evidence.

There are essentially four major components of computer forensics: collection, preservation, analysis, and presentation. Collection focuses on obtaining the digital evidence in a pure and untainted form. Preservation refers to the storage of this evidence using techniques that are guaranteed not to corrupt the collected data or the surrounding crime scene. Analysis describes the actual examination of the data along with the determination of applicability to the case. Presentation refers to the portrayal of evidence in the courtroom, and can be heavily dependent on the particular venue.

Accordingly to evidentiary rules, computer forensics falls under the broad category of “scientific evidence”. This category of evidence may include such things as expert testimony of a medical professional, results of an automated automobile crash test, etc. Rules governing the admittance of this category of evidence can vary based on jurisdiction and venue. The stringent Frye test, as articulated in Frye v. United States, 113 F. 1013 (D.C. Cir. 195) is the basis for some current state law and older federal case law. According to the Frye test for novel scientific evidence, the proponent of scientific testimony must show that the principle in question is generally accepted within the relevant scientific field. This essentially requires all techniques to be made “popular” with peers though publications and presentations prior to its acceptance in court. This is generally sufficient for acquisition techniques that have been in existence for many years, but it does not allow for the inclusion of evidence gathered through new and novel procedures. Considering the fast pace of technology and the limited time to gain general acceptance, this plays an integral role in computer forensics cases. In the early nineties the Frye test was repeatedly challenged.

New federal guidelines were eventually established in 1993 by the Supreme Court in Daubert v. Merrell Dow Pharmaceuticals. Inc., 509 U.S. 579, 113 S.Ct. 986, 17 L.Ed.2d 469 (1993) which adopted a more accommodating and practical approach for the admission of expert testimony in federal cases, including scientific evidence in the form of computer forensics cases. According to the Daubert test, before a federal trial court will admit novel scientific evidence based on a new principle or methodology, the trial judge must determine at the outset whether the expert is proposing to testify to scientific knowledge that will assist the trier fact to understand or determine a fact in issue. This entails a preliminary assessment of whether the reasoning or methodology underlying the testimony is scientifically valid and can properly be applied to the facts in issue. The court may then consider additional factors, such as the following, prior to introduction of the evidence: (1) whether the theory or technique has been tested, (2) whether it was subjected to peer review or publication, (3) whether it is generally accepted within the relevant scientific community, or (4) whether it has a known or potential rate of error.

Related work in the field of computer forensics has primarily been focused on the collection of evidence from non-volatile memory such as hard drives. The UNIX operating system, however, does offer a few utilities that are capable of collecting copies of all volatile memory. These programs are commonly referred to as “crash dump” utilities and are generally invoked following a serious bug or memory fault. In some cases they can be invoked manually, but they typically write their results out to the hard drive of the system, and often require a reboot following their usage. Their focus is that of debugging so they are of little use to forensics efforts. These methods operate by storing an entire copy of all volatile memory on the hard drive. They would require the development of a special utility to traverse the data and “recreate” process tables, etc to determine what programs were running. In addition, because this data is written to the hard drive it potentially destroys “deleted” files still present.

Accordingly, it can also be appreciated that a more robust approach is needed to collect forensic evidence associated computer system compromises, such that improved procedures can be implemented by appropriate personnel to aid criminal investigation and prosecution proceedings.

### BRIEF SUMMARY OF THE INVENTION

In its various embodiments, the present invention relates to a computerized method, a computer-readable medium and a system for collecting data from a computer that has short-term memory and long-term memory, respectively, for allowing temporary and more permanent data storage capabilities. Embodiments of the computerized method collect suspected data of interest that is expected to be characteristic of an operating system exploit, wherein the suspected data of interest resides within the short-term memory. The term “short-term memory” contemplates temporary data storage which is typically and primarily accommodated, for example, by one or more volatile RAM chips; however, short-term memory but can also be accomplished on an as needed basis by portions of non-volatile memory, such as a hard drive, when virtual memory allocation is employed.

One embodiment of the method comprises searching the short-term memory of the computer to located at least one target memory range therein which contains the suspected data of interest, and copying the suspected data of interest from the target memory range to an alternate data storage location, in a manner which avoids writing the suspected data of interest to any region of the volatile and non-volatile memory in which it resides. Another embodiment of the method locates data within volatile memory, namely RAM or the like, and copies it in a manner which avoids utilization of resources associated with the non-volatile memory region(s), namely the hard drive or the like. The alternate data storage location may be external to the computer and have an associated non-volatile memory, such as a removable media. The invention additionally contemplates that the alternate data storage location can be a previously unused area of internal computer memory, such as another hard drive, or areas of a hard drive in use that have been deleted but not overwritten. If desired, all unnecessary processes on the computer can be preliminarily halted and the computer's file system can be remounted in read-only mode prior to collection of the suspected data of interest. Also if desired, the computer's CPU can be halted after the data has been copied.

The suspected data of interest may correspond to one or more from a group consisting of: information associated with kernel modules, re-routed system call table addresses, information within the kernel's dynamic memory, information associated with a running image of the kernel, and process information associated with each running process on the computer. Where the suspected data of interest includes information associated with kernel modules, of particular interest could be module that has been loaded into the kernel module, or only those which have been hidden. In either case, location of the target memory range comprises searching the kernel's dynamic memory to ascertain a corresponding memory range for each such kernel module. Associated module data from each corresponding memory range is then copied to the alternate data storage location, thereby obtaining a respective image for each kernel module.

Where the suspected data of interest corresponds to system call table information, the target memory range may be located by scanning the system call table to identify an address associated with each function call therein. Each identified address can then be copied to the alternate to data storage location. Additionally, for each such identified address which falls outside of the kernel's static memory range, the associated range of the kernel's dynamic memory can be copied to the alternate data storage location. Advantageously, the computerized method can also copy a running image of the entirety of the computer's kernel.

Where the suspected data of interest includes process information associated with each process on the computer, and for a computer running a Linux operating system, various types of process-related data can be obtained. For each such running process, the process-related data may include an executable image from the computer's file system which corresponds to the running process, an executable image from memory for the running process, each file descriptor opened by the running process, an environment for the running process, each shared library mapping associated with the running process, command line data used to initiate the running process, and each mount point created by the running process.

According to another embodiment of the computerized methodology, different types of suspected data of interest are identified, thereby establishing a target data set. With respect to each type of suspected data of interest within the set, the short-term memory is searched to located an associated target memory range containing the suspected data of interest, which is then copied to the alternate data storage location.

A still further embodiment of the computerized method collects target forensics data from a computer, wherein the target forensics data resides within the volatile memory and is characteristic of a type of exploitation to the computer's operating system which renders the operating system insecure. According to this embodiment of the computerized method, the target forensics data is located within the volatile memory and copied to the alternate data storage location in a manner which avoids utilizing memory resources associated with the non-volatile memory. For purposes of the invention, a computer can be considered “secure” if its legitimate user can depend on the computer and its software to behave as expected. Accordingly, an “exploitation” or “compromise”, in the context of the present invention, can be regarded as any activity affecting the operating system of the computer, whether or not known to the legitimate user, which renders the computer insecure such that it no longer behaves as expected. Exploits and compromises can manifest in many ways, a rootkit installation being one example.

The present invention also relates to a computer-readable medium for use in collecting suspected data of interest which resides a computer's short-term memory, and which is expected to be characteristic of an operating system exploit. The computer-readable medium has executable instructions for performing a method comprising locating at least one target memory range containing the suspected data of interest, and enabling the suspected data of interest to be copied from the target memory range to an alternate data storage location in a manner which avoids writing the suspected data of interest to any long-term memory region of the computer. Advantageously, the executable instructions associated with the computer-readable medium can perform in accordance with the computerized methodology discussed above.

Finally, the present invention also provides a system for collecting target forensics data expected to be characteristic of an operating system exploitation. The system comprises a short-term memory for temporary data storage, a long-term memory for permanent data storage, a data storage location distinct from the short-term and long-term memories, and a processor which is programmed to locate a target memory range within the short-term memory which contains the suspected forensics data, and to copy the suspected forensics data from the target memory range to the data storage location in a manner which avoids writing the forensics data to either the long-term memory.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 represents a high level diagrammatic view of an exemplary security software product which incorporates the forensics data collection component of the present invention;

FIG. 2 represents a high level flow chart for computer software which incorporates forensics data collection;

FIG. 3 is a high level flow chart diagrammatically illustrating the principle features for the forensics data collection component of the invention;

FIG. 4(a) is a high level flow chart for computer software which implements the functions of the kernel module for the forensics data collection component;

FIG. 4(b) illustrates a representative main report page for the forensics data collection component which can be generated to provide conveniently links to various results output;

FIG. 5 represents a flow chart for computer software which implements the functions of the process freezing routine that is associated with the forensics data collection component of the present invention;

FIG. 6 represents a flow chart for computer software which implements the functions of the file system re-mounting routine that is associated with the forensics data collection component;

FIG. 7(a) represents a flow chart for computer software which implements the functions of the module collection routine associated with the forensics data collection component;

FIG. 7(b) illustrates a representative output report page which could be generated to visually tabulate results obtained for the module collection routine;

FIG. 8 represents a flow chart for computer software which implements the functions of the memory analysis subroutine that is called within the module collection routine of FIG. 7(a);

FIG. 9(a) represents a flow chart for computer software which implements the functions of the system call table collection routine associated with the forensics data collection component;

FIG. 9(b) illustrates a representative output report page which could be generated to visually tabulate results obtained for the system call table collection routine;

FIG. 10(a) represents a flow chart for computer software which implements the functions of the kernel collection routine associated with the forensics data collection component;

FIG. 10(b) illustrates a representative output report page which could be generated to visually tabulate results obtained for the kernel collection routine;

FIG. 10(c) represents a flow chart for computer software which implements the function for copying the running kernel associated with the forensics data collection component;

FIG. 11(a)-(h) collectively comprise a flow chart for computer software which implements the functions of the process collection routine, and its associated subroutines, for the forensics data collection component;

FIG. 11(i) illustrates a representative output report page which could be generated to visually tabulate results obtained for the process collection routine;

FIG. 12(a) shows, for representative purposes, an example of some images that can be collected according to the image collection subroutine of FIG. 11(b);

FIG. 12(b) shows, for representative purposes, results which might be displayed when the file descriptors are obtained for one of the process IDs shown if FIG. 12(a);

FIG. 12(c) shows, for representative purposes, an example of a recovered environment listing;

FIG. 12(d) shows, for representative purposes, an example of a recovered mount listing;

FIG. 12(e) shows, for representative purposes, a status summary recovered from a command line;

### DETAILED DESCRIPTION OF THE INVENTION

### I. Introduction

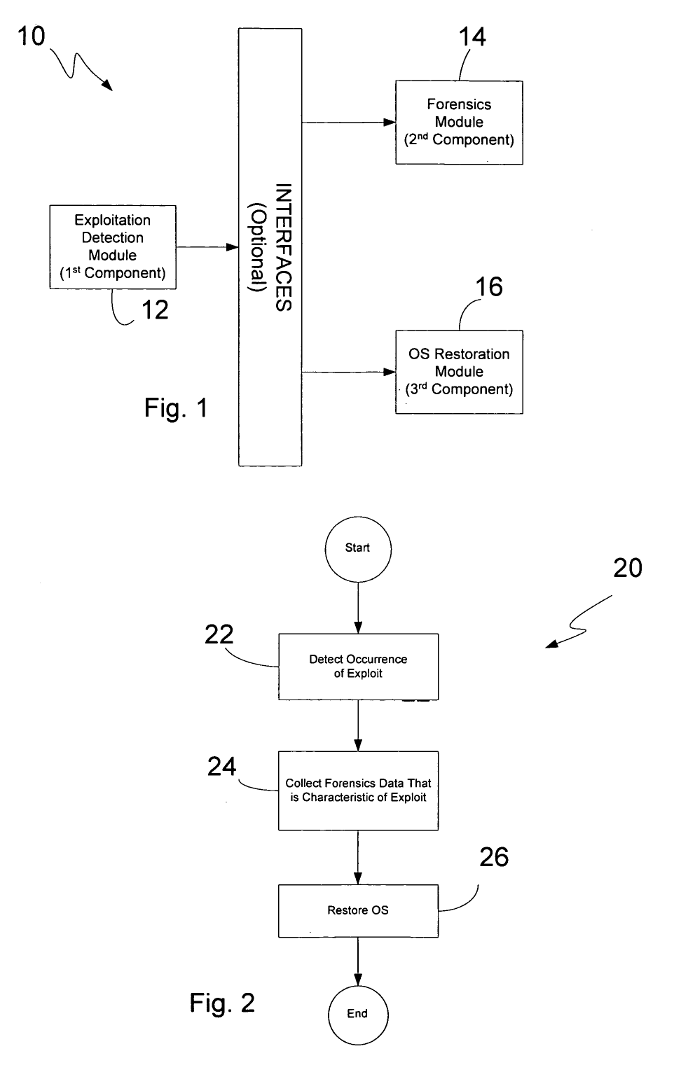

Aspects of this invention provide a software component, sometimes referred to herein as a forensics data collection component or module, which may be used as part of a system, a computer-readable medium, or a computerized methodology. This component was first introduced as part of a suite of components for handling operating system exploitations in our commonly owned, parent application Ser. No. 10/789,460 filed on Feb. 26, 2004, and entitled “Methodology, System, Computer Readable Medium, And Product Providing A Security Software Suite For Handling Operating System Exploitations”, which is incorporated by reference in its entirety. As discussed in that parent application, and as illustrated in FIG. 1 here, the forensics data collection component 14 may be part of a product or system 10 whereby it interfaces with other components 12 & 16. The components 12 & 16, respectively detect exploitation and restore a computer system to a pre-compromise condition. The exploit detection module 12 is the subject of our co-pending, and commonly owned, application Ser. No. 10/789,413 filed on Feb. 27, 2004. As shown in FIG. 2, the functionalities 6 of the forensics data collection component of the present invention may be used as part of a overall methodology 20 which also includes the functionalities 4 & 8 that are respectively associated with detecting occurrence of an OS exploit and OS restoration.

Important to an investigation is accessibility to all available evidence. The problem with traditional digital forensics is that the range of evidence is restricted by the lack of available methods. Most traditional methods focus on non-volatile memory such as computer hard drives. While this was suitable for older compromise techniques, it does not sufficiently capture evidence from today's sophisticated intruders.

The forensics data collection component 14 is preferably capable of recovering and safely storing digital evidence from volatile memory without damaging data present on the hard drive. Acquisition of volatile memory is a difficult problem because it must be transferred onto non-volatile memory prior to disrupting power to the computer. The digital information to be collected by the data collection component can be referred to as the suspected data of interest or the target forensics data. If this digital information is transferred onto the hard drive of the compromised computer it could potentially destroy critical evidence. In order to ensure that hard drive evidence is not corrupted this system, if desired, immediately 1) places all running processes in a “frozen” state, 2) remounts the hard drive in a read-only mode, and 3) preferably stores all recovered evidence onto an alternate data storage location, such as a large capacity removable media. The alternate data storage location can be any suitable memory device, whether internal or external to the computer, for preserving the data of interest for future analysis, while not disrupting the integrity of other memory areas where desirable information might exist (e.g., areas containing existing data or areas where data has been deleted but not overwritten). As such, the alternate data storage location may be a non-volatile removable media, another hard drive, or a previously unused area of an active hard drive, to name only a few representative examples. As a precautionary measure, utilization of a separate and pristine memory device is preferred. For illustrative purposes, the media might be a 256M USB 2.0 flash drive. In general, 1M is required for each active process. The forensics component is suitably capable of collecting and storing a copy of the system call table, kernel modules, the running kernel, kernel memory, and running executables along with related process information. Use of this system will enhance investigations by allowing the inclusion of hidden processes, kernel modules, and kernel modifications that may have otherwise been neglected. Following collection, the component can halt the CPU so that the hard drive remains pristine and ready to be analyzed by traditional methods. As with the exploitation detection component above, this approach can be applied to any operating system and has been proven through implementation on Linux 2.4.18.

By putting the processes in a frozen “zombie” state they can not longer be scheduled for execution, and thus any “bug out” mechanisms implemented by the intruder cannot be performed. In addition, this maintains the integrity of the process memory by not allowing it to be distorted by the behavior of the forensics module. Placing the hard drive in a read-only mode is important to protect it from losing integrity by destroying or modifying data during the forensics process. Likewise, all evidence that is collected is stored on large capacity removable media instead of on the hard drive of the compromised computer. These three requirements ensure that data stored on the hard drive remains uncontaminated just as it would if the power were turned off while evidence is safely collected from volatile memory.

The forensics data collection component addresses each of the important aspects of computer forensics discussed above in the Background section, namely, collection, preservation, analysis and presentation. On the one hand, it presents a technique for collecting forensics evidence, more generally forensics data, that is characteristic of an exploitation. The component preferably collects the data from volatile memory. It then stores the data on removable media to ensure the preservation of the scene as a whole. The results are efficiently organized to aid in the analysis process, and all of this is accomplished with an eye toward satisfying the guidelines established in Daubert so that acquired evidence can be presented in legal proceedings. The invention can be ported to virtually any operating system platform and has been proven through implementation on Linux. An explanation of the Linux operating system is beyond the scope of this document and the reader is assumed to be either conversant with its kernel architecture or to have access to conventional textbooks on the subject, such as Linux Kemel Programming, by M. Beck, H. Böhme, M. Dziadzka, U. Kunitz, R. Magnus, C. Schröter, and D. Verworner., 3^{rd} ed., Addison-Wesley (2002), which is hereby incorporated by reference in its entirety for background information.

In the following detailed description, reference is made to the accompanying drawings which form a part hereof, and in which is shown by way of illustrations specific embodiments for practicing the invention. The leading digit(s) of the reference numbers in the figures usually correlate to the figure number; one notable exception is that identical components which appear in multiple figures are identified by the same reference numbers. The embodiments illustrated by the figures are described in sufficient detail to enable those skilled in the art to practice the invention, and it is to be understood that other embodiments may be utilized and changes may be made without departing from the spirit and scope of the present invention. The following detailed description is, therefore, not to be taken in a limiting sense, and the scope of the present invention is defined by the appended claims.

Various terms are used throughout the description and the claims which should have conventional meanings to those with a pertinent understanding of computer operating systems, namely Linux, and software programming. Other terms will perhaps be more familiar to those conversant in the areas of intrusion detection. While the description to follow may entail terminology which is perhaps tailored to certain OS platforms or programming environments, the ordinarily skilled artisan will appreciate that such terminology is employed in a descriptive sense and not a limiting sense. Where a confined meaning of a term is intended, it will be set forth or otherwise apparent from the disclosure.

In one of its forms, the present invention provides a system for detecting an operating system exploitation that is implemented on a computer which typically comprises a volatile memory, such as a random access memory (RAM), a non-volatile memory, such as a read only memory (ROM), and a central processing unit (CPU). One or more storage device(s) may also be provided. The computer typically also includes an input device such as a keyboard, a display device such as a monitor, and a pointing device such as a mouse. The storage device may be a large-capacity permanent storage such as a hard disk drive, or a removable storage device, such as a floppy disk drive, a CD-ROM drive, a DVD-ROM drive, flash memory, a magnetic tape medium, or the like. However, the present invention should not be unduly limited as to the type of computer on which it runs, and it should be readily understood that the present invention indeed contemplates use in conjunction with any appropriate information processing device, such as a general-purpose PC, a PDA, network device or the like, which has the minimum architecture needed to accommodate the functionality of the invention. Moreover, the computer-readable medium which contains executable instructions for performing the methodologies discussed herein can be a variety of different types of media, such as the removable storage devices noted above, whereby the software can be stored in an executable form on the computer system.

The source code for the software was developed in C on an ×86 machine running the Red Hat Linux 8 operating system (OS), kernel 2.4.18. The standard GNU C compiler was used for converting the high level C programming language into machine code, and Perl scripts where also employed to handle various administrative system functions. However, it is believed the software program could be readily adapted for use with other types of Unix platforms such as Solaris®, BSD and the like, as well as non-Unix platforms such as Windows® or MS-DOS®. Further, the programming could be developed using several widely available programming languages with the software component coded as subroutines, sub-systems, or objects depending on the language chosen. In addition, various low-level languages or assembly languages could be used to provide the syntax for organizing the programming instructions so that they are executable in accordance with the description to follow. Thus, the preferred development tools utilized by the inventors should not be interpreted to limit the environment of the present invention.

A product embodying the present invention may be distributed in known manners, such as on a computer-readable medium or over an appropriate communications interface so that it can be installed on the user's computer. Furthermore, alternate embodiments which implement the invention in hardware, firmware or a combination of both hardware and firmware, as well as distributing the software component and/or the data in a different fashion will be apparent to those skilled in the art. It should, thus, be understood that the description to follow is intended to be illustrative and not restrictive, and that many other embodiments will be apparent to those of skill in the art upon reviewing the description.

The invention has been employed by the inventors utilizing the development tools discussed above, with the software component being coded as a separate module which is compiled and dynamically linked and unlinked to the Linux kernel on demand at runtime through invocation of the init_module( ) and cleanup_module( ) system calls. As stated above, Perl scripts are used to handle some of the administrative tasks associated with execution, as well as some of the output results. The ordinarily skilled artisan will recognize that the concepts of the present invention are virtually platform independent. Further, it is specifically contemplated that the functionalities described herein can be implemented in a variety of manners, such as through direct inclusion in the kernel code itself, as opposed to one or more modules which can be linked to (and unlinked from) the kernel at runtime. Thus, the reader will see that the more encompassing term “component” or “software component” are sometimes used interchangeably with the term “module” to refer to any appropriate implementation of programs, processes, modules, scripts, functions, algorithms, etc. for accomplishing these capabilities. Furthermore, the reader will see that terms such, “program”, “algorithm”, “function”, “routine” and “subroutine” are used throughout the document to refer to the various processes associated with the programming architecture. For clarity of explanation, attempts have been made to use them in a consistent hierarchical fashion based on the exemplary programming structure. However, any interchangeable use of these terms, should not be misconstrued as limiting since that is not the intent.

### II. Forensics Data Collection Component

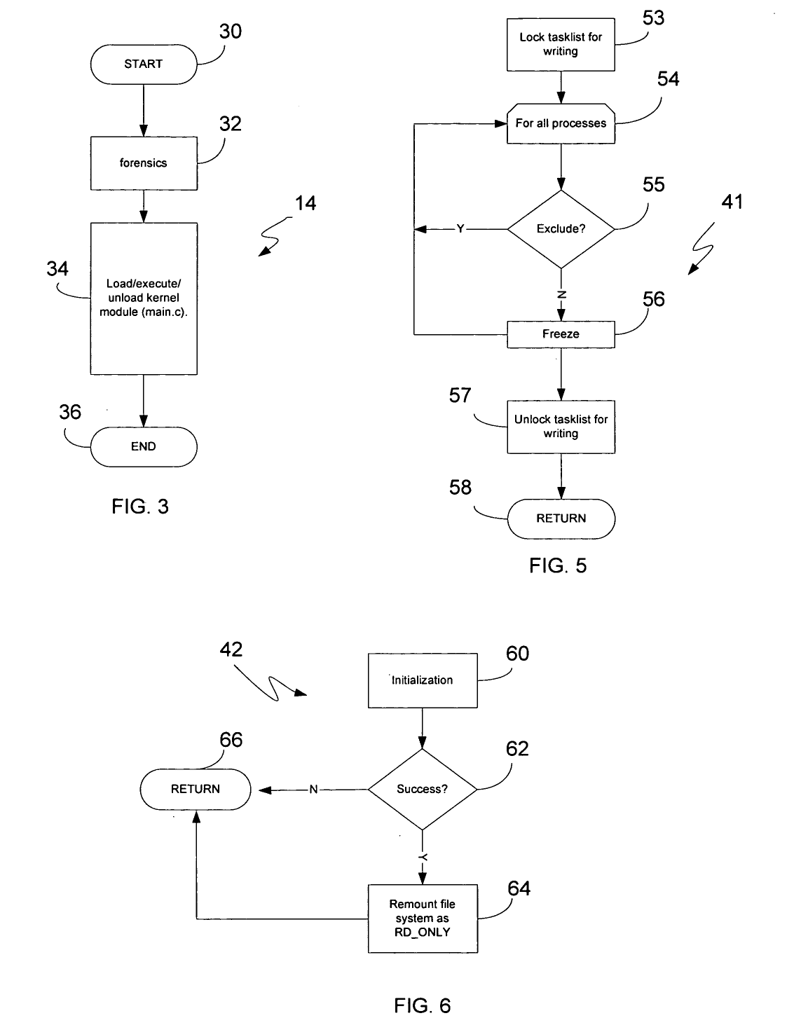

The forensics data collection component 14 is introduced in FIG. 3. When the forensics component 14 is started at 30, a prototype user interface 32 may be launched. This is preferably a “shell” script program in “/bin/sh”, and is responsible for starting the forensics kernel module (main.c.) which is loaded, executed, and then unloaded. The forensics component ends 36 once its associated kernel module 34 completes execution.

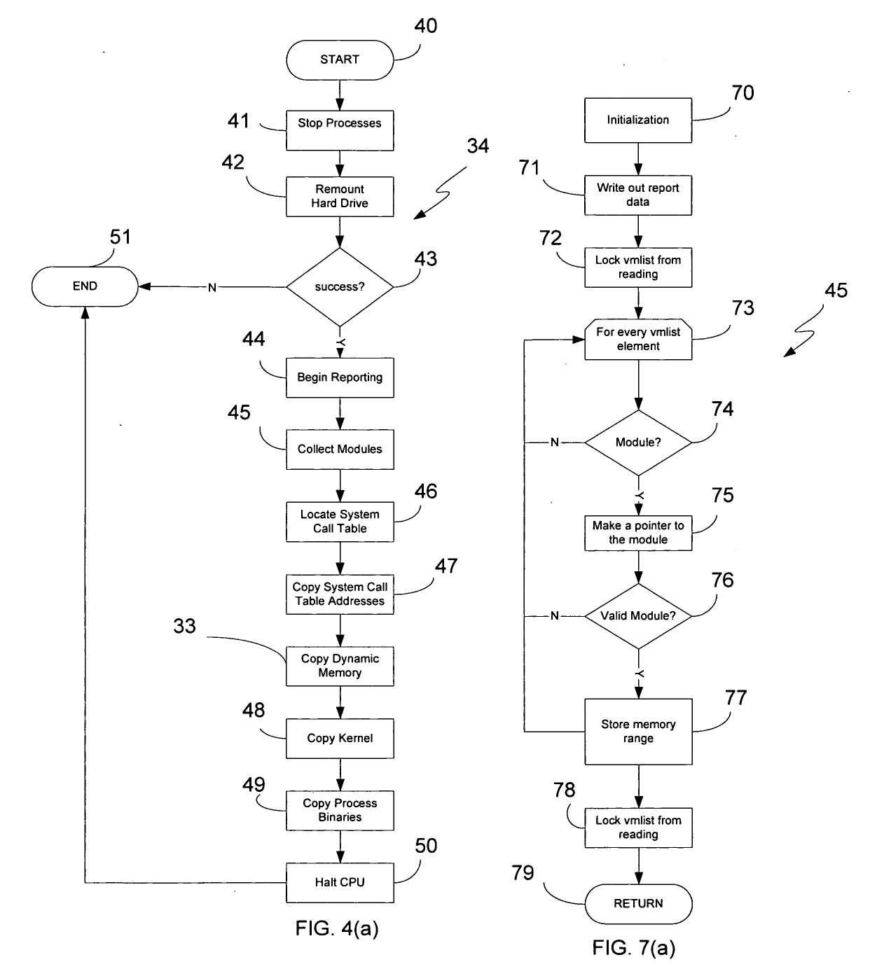

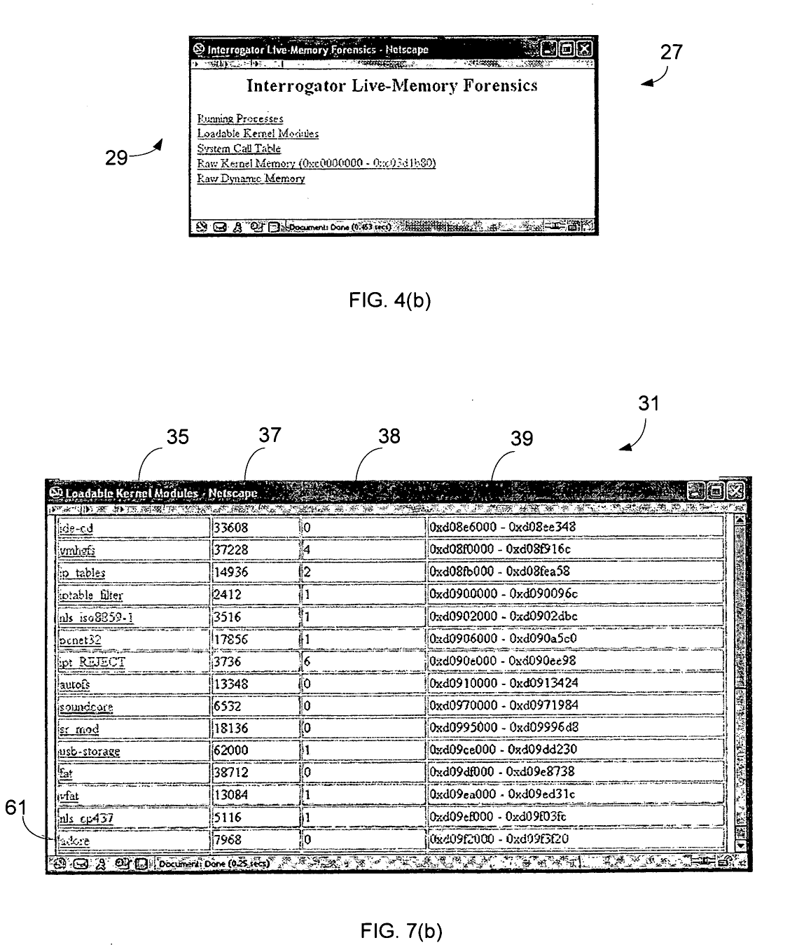

A high-level program flowchart illustrating the principle features for forensics kernel module 34 is shown in FIG. 4(a). Following start 40, an initialization (not shown) takes place in order to, among other things, initialize variables and file descriptors for output results. A global header file is included which, itself, incorporates other appropriate headers through #include statements and appropriate parameters through #define statements, all as known in the art. A global file descriptor is also created for the output summary results, as well as a reusable buffer, as needed. Modifications to the file descriptor only take place in _init and the buffer is used in order by functions called in _init so there is no need to worry about making access to these thread safe. This is needed because static buffer space is extremely limited in the virtual memory portion of the kernel. One alternative is to kmalloc and free around each use of a buffer, but this creates efficiency issues. As for other housekeeping matters, initialization can also entail the establishment of variable parameters that get passed in from user space, appropriate module parameter declarations, function prototype declarations, external prototype declarations for the forensic data collection module, and establishment of an output file wrapper. This is a straightforward variable argument wrapper for sending the results to an output file. It uses a global pointer that is initially opened by ₁₃ init and closed with _fini. In order to properly access the file system, the program switches back and forth between KERNEL_DS and the current (user) fs state before each write. It should be appreciated that the above initialization, as well as other aspects of the programming architecture described herein, is dictated in part by the current proof of concept, working prototype status of the invention, and is not to be construed in any way as limiting. Indeed, other renditions such as commercially distributable applications would likely be tailored differently based on need, while still embodying the spirit and scope of the present invention.

Once initialized, a function 41 is called to prevent execution of all processes on the computer. The processes are placed in a “frozen” state so that no new processes can be initialized. This prevents the execution of potential “bug out” mechanisms in malicious programs. Thereafter, at 42, the hard drive is remounted using the “READ-ONLY” flag to prevent write attempts that could possibly modify evidence data on the hard drive. If the remounting of the hard drive is deemed unsuccessful at 43, the system exists and the program flow for forensics kernel module 34 ends at 52. It should be understood that operations 41 and 42 are optional.

If, however, hard drive remounting is successful the program continues at 44 to call a function to create initial HTML pages in preparation of displaying program results. All kernel modules, whether visible or hidden from view, are collected from memory at 45 and stored onto the removable media. Because the address of the system called table is not publicly “exported” in all operating system kernels, it is preferably determined after 46. Sub-routine 46 of FIG. 4(a) corresponds to subroutine 103 in FIGS. 10(a) & 10(b) of our parent application Ser. No. 10/789,460, incorporated by reference. This function is based on a publicly available technique, namely that utilized in the rootkit “SuckIT” for pattern matching against the machine code for a “LONG JUMP” in a particular area of memory, wherein the address of the JUMP reveals the system call table; however, other non-public techniques to do this could be developed if desired. At 47, the value/address of each system call is stored on removable media. The range of dynamic memories is then stored on removable media at 33. A copy of the kernel in memory on the computer system is then stored onto removable media at 48. At 49, a copy of the process binary from the hard drive and a copy of the stored image from memory are stored on removable media. This will collect both the binary that was executed by the intruder and a decrypted version if encryption is used. Once the entire system has completed, the processor is “halted” at 50 and the computer automatically turns itself off. Thereafter, the program flow for forensics kernel module 34 ends at 51. Other than the requirement that the process halting and hard drive remounting (if they are desired) must take place prior to the forensics collection functionality, the remaining forensics data collection functions of FIG. 4(a) may be reordered if desired.

FIG. 4(b) shows a main report page 27 which can be generated by the forensics data collection component. As the description continues below to explain the various functions associated with the forensics kernel module 34 of FIG. 4(a), at times reference will made to the various links 29 within the main report page 27 from which additional output report pages can be displayed. All results are preferably stored on large capacity external media. The HTML web pages are automatically generated when the system is run to aid in the navigation of recovered data.

With that in mind, various ones of the embedded functions called within the forensics kernel module 34 will now be described in greater detail with reference to FIGS. 5-11(h). Turning first to FIG. 5, the function 41 for preventing execution of all process is described. Since remounting of the hard drive could theoretically trigger this event, all processes are first placed in a frozen state. This is accomplished by changing the state flag in their task structure to TASK_ZOMBIE. More particularly, when function 41 is called, the kernel write locks must be acquired prior to modifying in the task list. Accordingly, the task list is locked for writing at 53. A loop is initiated at 54 for each process that is scheduled for execution. The current implementation uses the built-in Linux kernel for_each_task function, but it can be made more generic for easier portability across other operating system platforms. Processes must be excluded in order to retain a skeleton functionality of the operating system. More specifically, processes are excluded which are necessary for writing the collected data out to the USB drive or other removable media. Presently, this is a manual process and the user is asked to enter the process ID of the excluded process; of course, this can be easily automated if desired. In any event, if a process is excluded at 55 the loop returns to 54 to address the next process that is scheduled for execution.

If not excluded at 55, the process is frozen at 56 from being scheduled further by changing its state to “ZOMBIE”. The ZOMBIE flag refers to a process that has been halted, but must still have its task structure in the process table. In essence, then, all of its structures and memory will be preserved but it is no longer capable of executing. This modification is related to an accounting structure used only by the scheduling algorithm of the operating system and has no effect on the actual functionality of the process. Therefore, any data collected about the process is the same as if it were still executing; this action simply prevents future scheduling of the process. With the exception of the daemon used to flush data out to the USB drive and the processes associated with the forensics kernel module, all other processes are frozen immediately upon loading of the module. The only real way a process could continue to execute after being marked as a zombie would be if the scheduler of the operating system was completely replaced by the attacker. In any event, after the pertinent processes are frozen, the kernel write locks are released at 57 and control is returned at 58.

Although the freezing of processes technically prevents most write attempts to the hard drive because there are no programs running, this system applies an additional level of protection by forcing the root partition of the file system to be mounted in “read only” mode. Remounting the file system in this mode prevents all access to the hard drive from both the kernel and all running processes. This approach could potentially cause loss of data for any open files, but the same data would have been lost anyway if the computer was turned off using traditional means. The algorithm 42 used to protect the hard drive is demonstrated in FIG. 6. Upon initialization 60, an attempt is made to create a pointer to the root file system super block. An inquiry is then made at 62 to determine if the pointer is valid and if the file system supports remounting. If not, function 42 returns at 66. If, however, the response at 62 is in the affirmative, the file system is remounted RD_ONLY (read only). Doing this prevents future write attempts to the hard drive. It should be noted that operating systems can have multiple file systems mounted at any given time. As a prototype implementation at this point, the present system only remounts the “root” or primary file system, but as an expansion it could remount all if necessary. The implementation difference of this is minimal, since it merely entails multiple remounts. Accordingly, the remounting technique described herein could readily be expanded to remount all partitions as well as implement other halting practices for redundancy, as required.

Next the module begins to prepare the output reporting in subroutine 44 by opening output file pointers and initializing the HTML tables used to graphically display the results. The module(s) collection function 45 is now described with reference to FIG. 7(a). Since loadable kernel modules are popular implementation methods used by kernel rootkits, the forensics data collection component is preferably designed to collect all modules currently loaded into memory. Detection of the modules is based on the approach discussed with reference to function 42 in FIGS. 4, 7 & 8 of our parent application Ser. No. 10/789,460, incorporated by reference, with reference to it's exploitation detection component. The module detection does not rely on modules viewable through standard means, as kernel modules can be easily unlinked by intruders which prevents detection through the operating system. The technique employed in the present system instead searches through dynamic kernel memory for anomalies that have the compelling characteristics of kernel modules. The range of memory associated with kernel modules is retrieved and stored on the removable media. Each image collected contains all functionality of the kernel module, but is not able to be directly loaded into memory because it is missing the ELF header. This header is merely required for dynamically loading programs and modules into memory by the operating system and has no effect on the behavior of the module itself. The retrieved image contains all of the data necessary to determine the functionality of the recovered module. In an effort to maintain the original integrity of the image retrieved, generated headers are not automatically appended to these modules. A new header can be easily affixed to the retrieved image later if necessary.

The function 45 responsible for this collection of the modules is shown in FIG. 7(a), and is again similar to function 42 above for the detection component in our earlier application. That is, since the forensics module can be designed to operate independently of the detection module, if desired, its module collection routine 45 by default would in such case retrieve a copy of every module in memory based on the notion that it is preferred to collect everything and discard what is not needed at a later time. However, in a situation where the forensics component/module is interfaced with the exploit detection component/modules, it would likely only collect data on modules already deemed hidden by the detection component. This same logic applies to other collection aspects of the forensics component and the description of it is to be understood bearing this capability in mind.

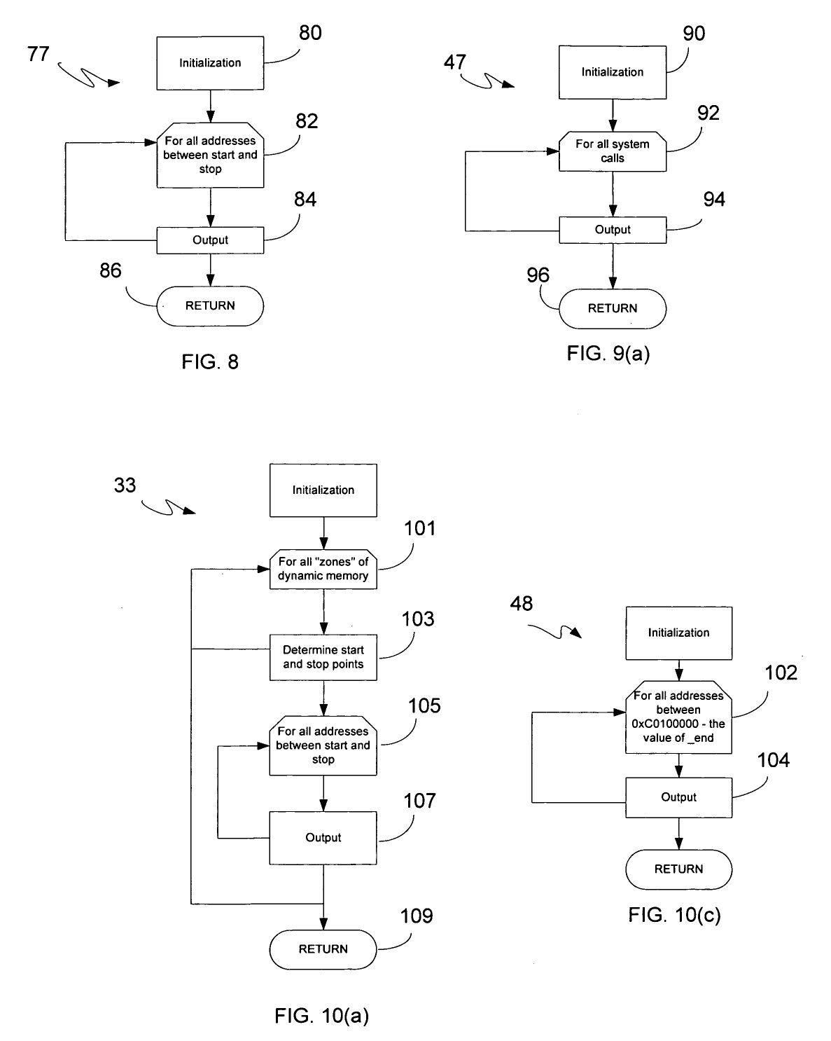

Accordingly, upon initialization 70, the data structures and pointers utilized in its operation are created. Headers and columns for the reports are established at 71 and the read lock for the vmlist is acquired at 72. For each element in the vmlist at 73, an inquiry is made as to whether the element (page) of memory has the look and feel the kernel module at first glance. In other words, a determination is made as to whether it begins with the value sizeof(struct module). If so, a pointer is made at 75 to what appears to be a module structure at the top of the selected memory page. A verification is made at 76 to determine if important pointers of the module structure are valid. If not, the loop returns to 73 and continues to the next element, if any, of the vmlist. If the module is deemed valid, at 77 a subroutine is invoked to store the range of memory where the kernel module is located. Once each element in the vmlist has been analyzed, it is unlocked from reading at 78 and control is returned at 79. Embedded subroutine 77 is responsible for writing the raw module data out to disk, and is shown in FIG. 8. Following initialization at 80, whereby the necessary data structures and report output files are prepared, a loop is begun at 82 for each address between “start” and “stop”. At 84, the value of each such address is output to the removable media, and the subroutine 77 thereafter returns at 86 to calling function 45 in FIG. 7(a).

All loadable kernel modules are recovered even when intruders hide them by removing their presence in the module queue. Representative FIG. 7(b) shows an example of results 31 generated by the forensics component when the above kernel module collection routine is executed. The results can be displayed by clicking on the appropriate link from main page 27 in FIG. 4(b). As may be seen, the table of FIG. 7(b) includes various columns 35, 37, 38 & 39 which respectively provide 1) a link to the recovered image, 2) the size of the image, 3) the number of references to the module, and 4) the memory address space that the module is located in. The highlighted entry 61 demonstrates that, even though the test, hacker rootkit Adore is automatically removed from the queue as a hiding technique, it is recovered by this system. Moreover, the address range listed (0xd09f2000-0xd09f3f20) can be correlated with the patched calls list generated by the system call table collection module described below.

Most kernel rootkits operate by replacing function pointers in the system call table. This forensics component 14 recovers and stores these addresses so that a forensics expert can later determine if they have been modified, and if so where they have been redirected. The data of the addresses can be reviewed later to determine the exact functionality of the replacements. The procedure for obtaining the address of the system call table was discussed above, and can be used for comparison purposes.

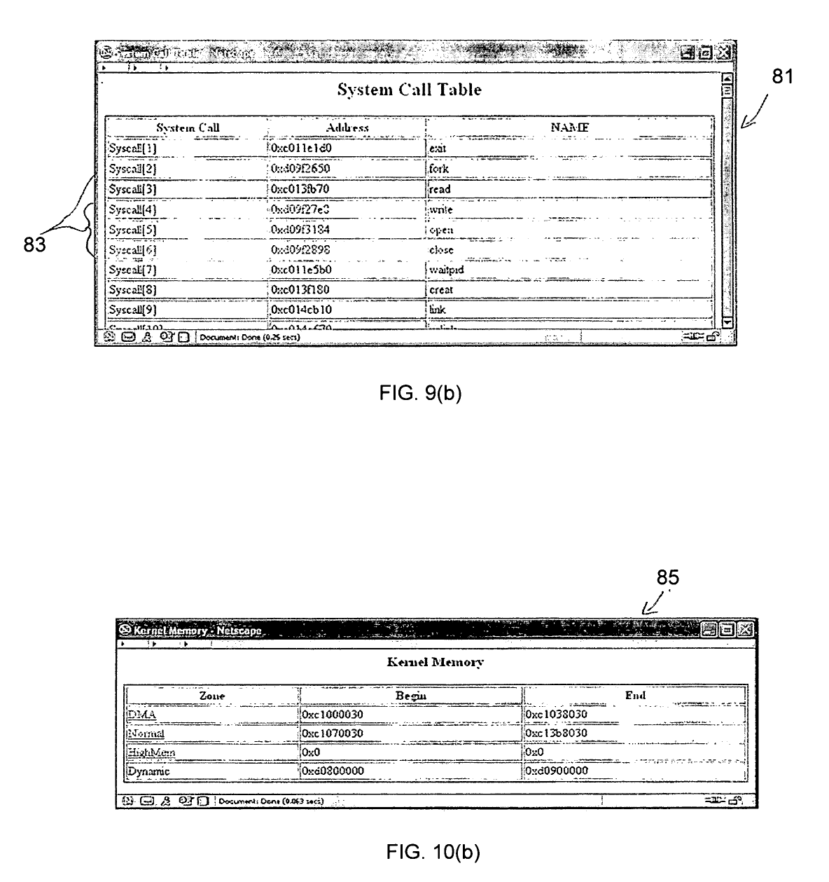

Following identification, a function corresponding to box 47 in FIG. 4(a) stores the addresses of the system call table, and a flowchart corresponding to this functionality is shown in FIG. 9(a). Since the functionality of routine 47 is similar to that described in FIGS. 10(a)-10(d) of our parent application Ser. No. 10/789,460, incorporated by reference, it can be summarized as illustrated in FIG. 9(a). Function 47 initializes at 90, as with others, whereby necessary data structures and report output files are prepared. A loop begins at 92 through each call in the system call table and the address of each encountered call is output at 94. Results are placed in a table on the removable media, and addresses found will either fall in the 0xC0100000—_end address range which legitimately belongs to the kernel, or they will reside in the dynamic address range (0xXXXXXXX or 0xFXXXXXX depending on machine architecture). Once the output results are generated, the function returns at 96.

FIG. 9(b) shows a representative example of results 81 tabulated by the forensics component when the system call table collection routine is executed. The results can be displayed by clicking on the appropriate link from main page 27 in FIG. 4(b). As illustrated by the various columns in the table, the system generates a listing of the call number, address, and name for each entry of the system call table. This data can be visually inspected by an expert to identify anomalies (i.e., when a call points out of the memory address space for the static kernel), or analysis software can be designed to aid in the process. The benefit of recording each call address is that it can be correlated to the exact function in memory. For example, the call addresses indicated by the shadowed rows 83 appear to be malicious because they are out of the static kernel range listed on the main report page (0xC0100000-0xC03d1b80). Instead they are located in the 0xDXXXXXXX range. Further, each address can be associated with a specific function located, for instance, within the Adore module highlighted in FIG. 7(b). Therefore, this demonstrates that 1) the system call table has been patched, 2) the module responsible for patching the module is “adore”, and 3) the exact functionality of the patched function is captured and stored on removable media for additional analysis.

It is also desirable that the forensics data collection component store the kernel's dynamic memory for evidentiary purposes because addressing data recovered from the system call table collection, algorithm 47 above, can be used to cross-reference the actual replacement function in memory to determine its functionality. That is, in the event that the addresses of the system call table point elsewhere, the kernel's dynamic memory is collected to capture intruder implants that directly inject themselves into the memory of the kernel itself. The evidence found in this memory would otherwise be lost if traditional non-volatile recovery methods were conducted. In the present implementation of the forensics component, only the DMA and Normal memory are physically retrieved; however the system is designed and capable of retrieving all memory as well if desired.

Accordingly, it is desirable to collect the kernel's dynamic memory, identified as function 33 in FIG. 4(a). This function is illustrated in FIG. 10(a). The respective start and stop address values of this collection function 33 are based on information created and stored by the kernel. Specifically, the zone_table[i]→zone_start_mapnr is the start address, and this value plus zone_table[i]→size is the ending address. Thus, for each zone of memory identified at 101 by the zone_table address, the start and stop addresses are determined at 103. For all addresses between them at 105, the corresponding memory is written to the output file at 107. Thereafter, at 109, function 33 returns. Representative FIG. 10(b) shows an example of results 85 generated by the forensics component when the kernel memory collection routine is executed. Again, these results can be displayed by clicking on the appropriate link from main page 27 in FIG. 4(b).

It is very difficult to identify an intruder and collect evidence against them when the running kernel of the system is modified. The best method of recovering this evidence is to store a copy of the image itself and compare it against what is physically located on disk, or against a trusted copy. From the fourth link on the main report page 27 of FIG. 4(b), a copy of the kernel taken from memory can be analyzed. For representative purposes, main report page 27 shows in the link that forensics component retrieved the kernel physically located in 0xC0100000-0xC03d1b80.

More sophisticated intruders have developed mechanisms for directly modifying the running kernel instead of relying on loadable kernel modules or patching over the system call table. Therefore, this system may also store, at 48 in FIG. 4(a), a copy of the running kernel for analysis by a forensics expert. The algorithm for accomplishing this is illustrated in FIG. 10(c). For all system calls 102, this function 48 operates by retrieving a copy of all memory between 0xC0100000-the _end variable and outputs this information at 104.

Prior to halting the entire system at 50 in FIG. 4(a), the final function called by the forensics kernel module 34 pertains to the collection of process information, identified at 49 in FIG. 4(a). One of the prime benefits to collecting evidence from volatile memory is to recover data from running processes. These processes may include backdoors, denial of service programs, and collection utilities that if deleted from disk would otherwise not be detected. Several aspects of processes are important in the evidence collection process. For each process that is running, the forensics component collects: the executable image from the proc file system, the executable from memory, file descriptors opened by the process, the environment, the mapping of shared libraries, the command line, any mount points it has created, and a status summary. The results may also be stored on a removable media and can be easily navigated using the HTML page that is automatically generated.

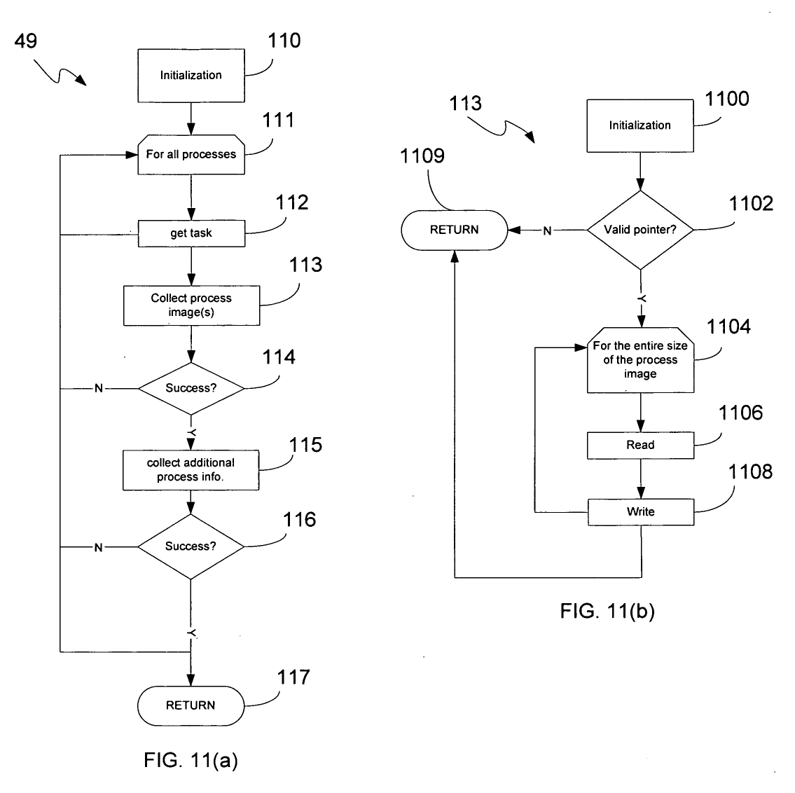

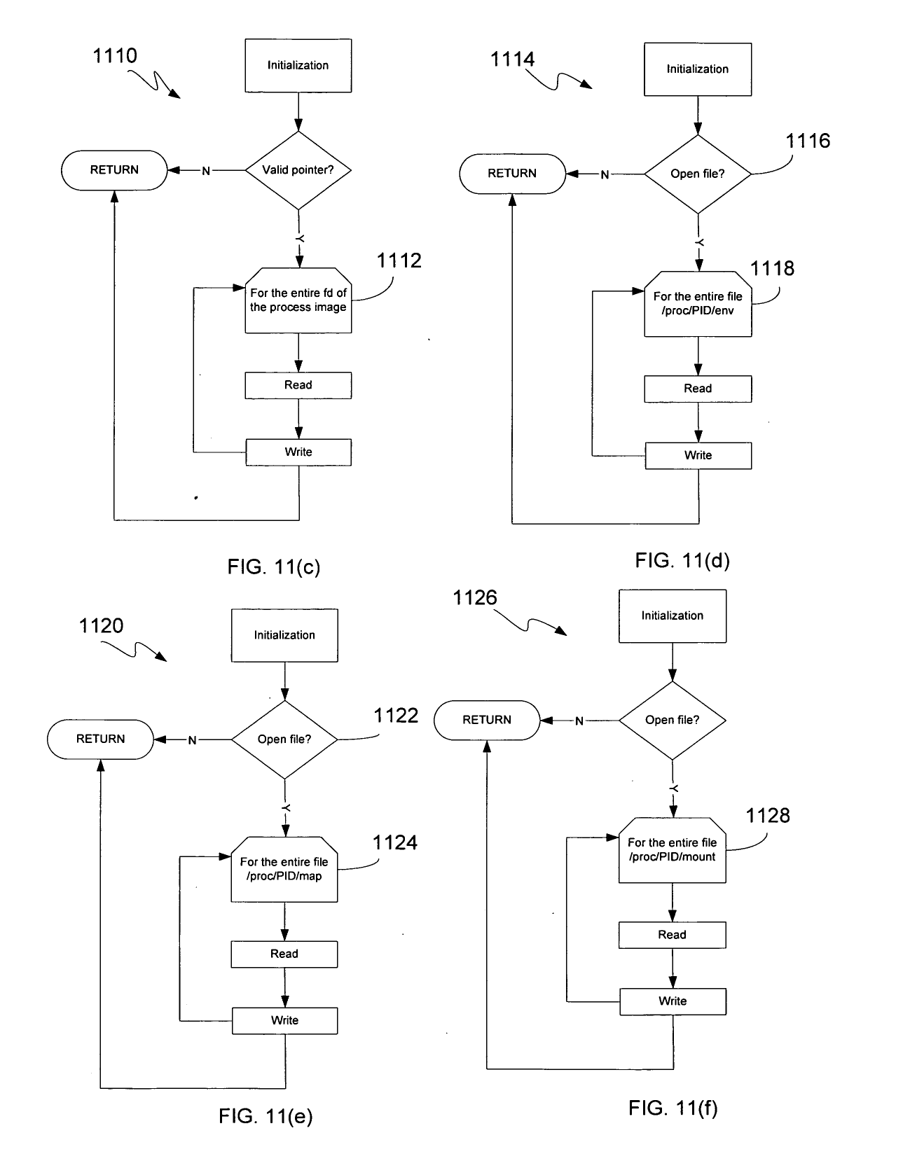

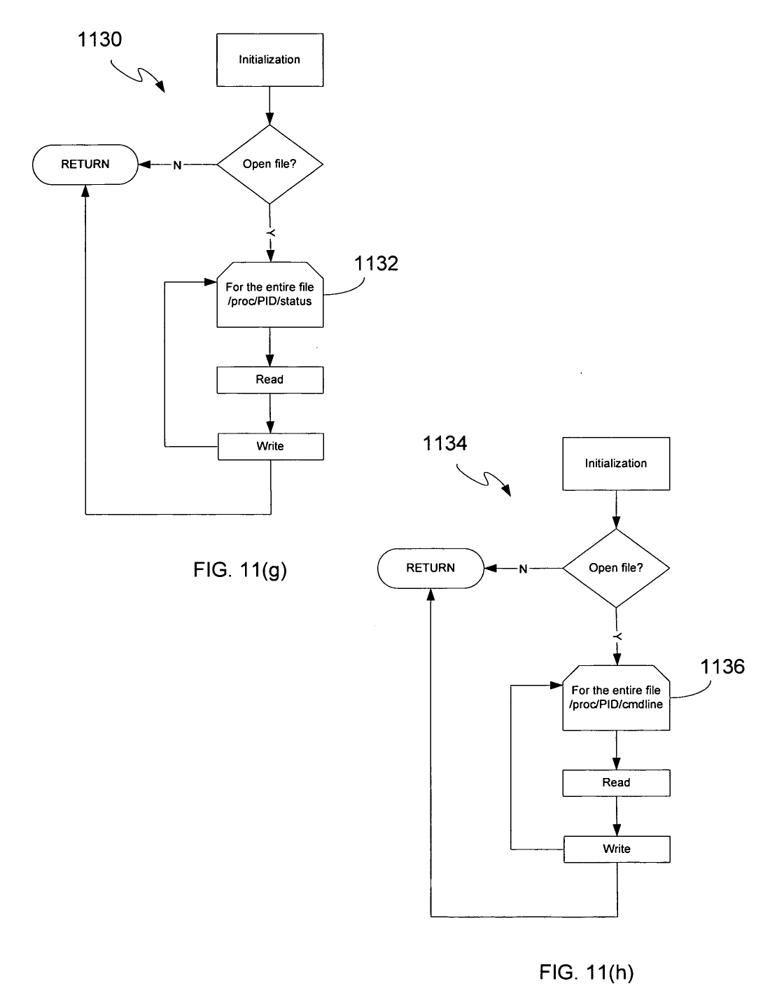

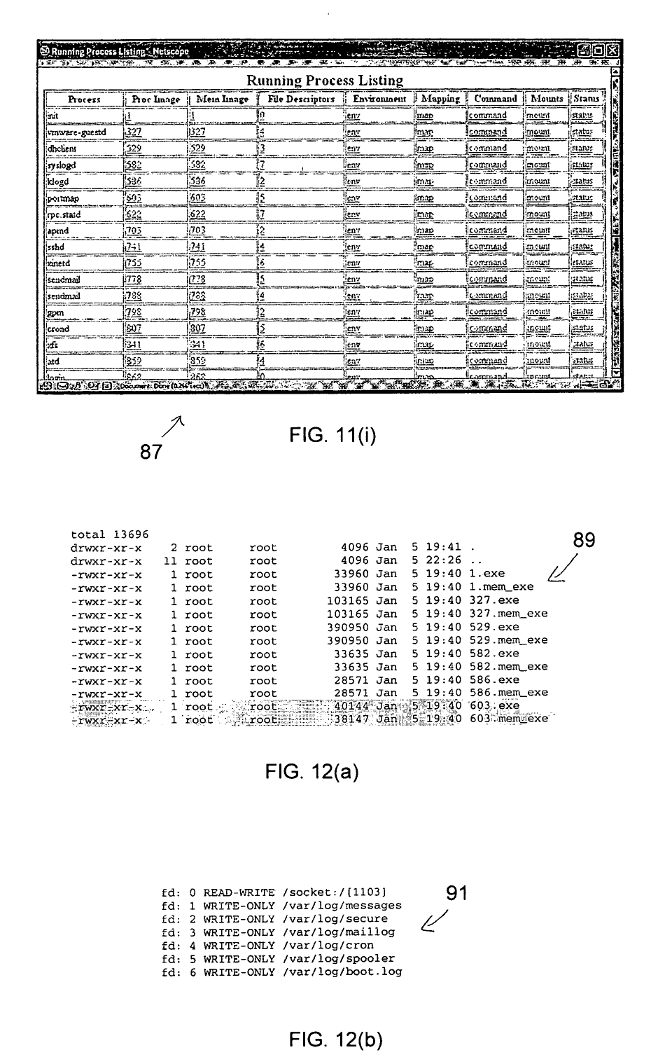

A global function 49 for acquiring this various information is shown in FIG. 11(a). After the usual initialization at 110, algorithm 49 begins at 111 to loop through every possible process ID and, for each, attempts to obtain a task structure at 112. A subroutine 113 (FIG. 11b) is then called to collect process image(s) from memory which can later be compared to the image on the hard drive or a pristine version stored elsewhere to identify signs of a compromise. If image collection is successful at 114, further processing information is collected via additional subroutines, collectively 115 (FIGS. 11c-h). Otherwise, the loop returns to the next process ID at 111. Following successful collection of the additional processing information at 116, algorithm 49 returns at 117.

The technique for retrieving the executable from the proc file system is straightforward—the file is opened and re-written to removable media. This version of the binary retrieved by subroutine 113 comes from a symbolic link to the original executable. This will provide evidence of the initial binary that is started by the intruder. However, many intruders have implemented binary protection mechanisms such as burneye to make analysis of the executable more difficult. Utilities such as this are self-decrypting which means that once they are successfully loaded into memory they can be captured in a decrypted form where they can be more easily analyzed. To take advantage of this weakness and enable the collection of further evidence this forensics component collects a copy of the image from memory as well. The subroutine 113 for collecting each process image from the proc file system is shown in FIG. 11(b). This method actually retrieves a copy of each running image from memory that can be used to reverse engineer and analyze executables that have implemented many forms of binary protection. After initializing at 1100, a verification is made at 1102 as to whether the pointer to the memory image is valid. Assuming this to be the case, a loop begins at 1104 through each address of the process binary in memory. For each such encountered address, a buffer of the binary is read from memory at 1106, and this buffer is written out to the removable media that 1108. Thereafter, at 1109 the algorithm returns.

In addition to the binary itself, much more forensics evidence can be collected about processes and the activities of intruders by recovering process information. Accordingly, other useful processes information contemplated, collectively, by subroutine box 115 in FIG. 11(a) will now be discussed. One such item of information is the collection of open file descriptors. Most programs read and write to both files and sockets (i.e., network connections) through file descriptors. For example, if a malicious program is collecting passwords from network traffic it will likely store them in a log file on the hard drive. This log file will be listed as an open file descriptor and will give a forensics expert an indication of exactly where to look on the hard drive when conducting traditional non-volatile analysis. FIG. 11(c) illustrates the flow of a function 1110 capable of retrieving this information from the process's virtual memory. This functional flow is identical to that associated with subroutine 113 in FIG. 11(b) for collecting the process image(s), except that the internal loop 1112 pertains to each file descriptor of the process binary in memory. Function 1110 prints the full path of every open file descriptor for the process by recursively following the pointers to each directory entry. In addition to the name and descriptor number it stores their access status (i.e., if they were opened for reading only, writing only, or if they can be both read and written to).

Because command lines are visible in process listings when the process is not hidden, some intruders choose to pass necessary parameters into programs through environment variables. For example, the command line “telnet 10.1.1.10” implies that a connection is being made to the IP address 10.1.1.10. To make things more difficult for an analyst an intruder could export an environment variable with the IP address in it to the program and use only “telnet” on the command line. Therefore, the forensics component also preferably retrieves a copy of the environment from memory as well. An example of a function flow 1114 used to recover this information from memory is shown in FIG. 11(d), and is again similar to that associated with subroutine 113 in FIG. 11(b) for collecting the process image(s), except that a verification 1116 takes place to make sure the environment file can be opened from the proc file system so that an internal loop procedure 1118 can be performed to read a buffer of the binary from memory and write it to the removable media while the environment file still has data in it.

Shared library mappings, mount points, and summary information generally do not provide directly incriminating evidence, but they can be useful in the analysis portion of the behavior of a process or the intentions of an intruder. Flow charts 1120, 1126 & 1130 for collection of these types of process information appear, respectively, as FIGS. 11(e)-(g). As shown in the figures, the functional flow for these items proceed the same as for the file environment above, excepting of course the actual identities of the files retrieved by their respective internal loops 1124, 1128 & 1132.

Another key point of information for a process is the command line used to start the program. Many intruders obfuscate the executables and add “traps” which cause them to operate in a different manor when they are started with incorrect command line options. This is analogous to requiring a special “knock” on a door which tells the person listening if they should answer it or not. Therefore, the forensics component also preferably retrieves an exact copy of the command line used to start the process from memory. This is associated with subroutine 1134 in FIG. 11(h) for collecting the process command lines which loops through the file's entirety at 1136.

Perhaps the most important component of this system is the collection of processes and their corresponding information. Accordingly, with an appreciation of FIGS. 11(a) through 11(h), representative FIG. 11(i) shows an example of what results 87 automatically generated by the forensics component might look like when the process collection routine 49 is implemented. It is again understood that these results can be accessed by clicking on the appropriate link from main page 27 in FIG. 4(b). This table contains: the name of the process, the process ID, a link to both the image from the proc file system and retrieved from memory, a link to the open file descriptors, a link to the environment, shared library mapping information, command line, mount points, and status summary.

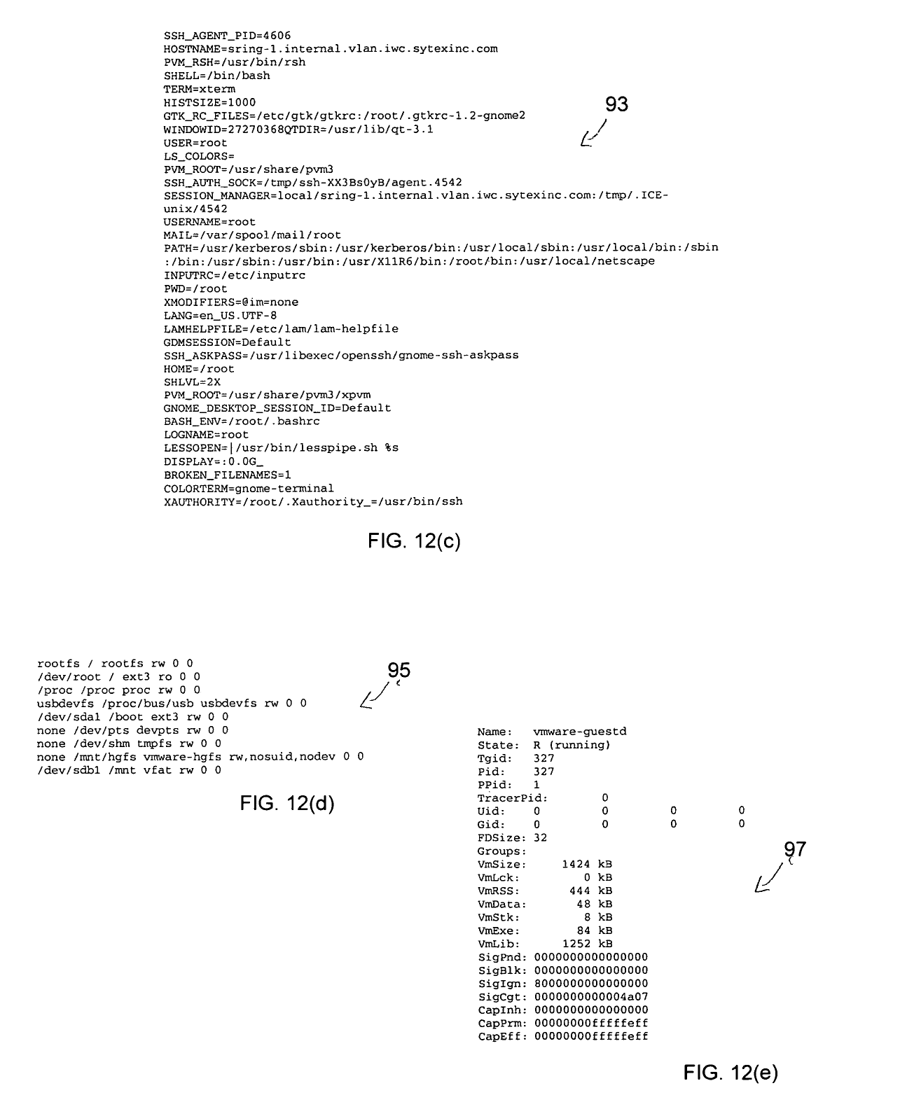

The image links are binary files that can be executed directly from the command line if desired. FIG. 12(a) representatively shows an example of some of the images 89 that could be collected. In most cases both the proc file system image (X.exe) and the memory retrieved image (X.mem_exe) will be identical. However, in instances where the binary is self-decrypting such as PID 603 in FIG. 12(a), the image in memory will be slightly less in size and will not be encrypted like the image from disk. File descriptors give good indications of places to analyze on disk. For instance, the results 91 for PID 582 are shown in FIG. 12(b) This process is syslogd which is responsible for writing to the log files listed above. Similarly, an intruder's program designed to collect passwords and store them on disk will be recovered and listed as well. An example of a recovered environment for sshd is illustrated by the representative listing 93 in FIG. 12(c). A representative example of a recovered mount listing 95 is shown in FIG. 12(d). A representative example of a command line used is:

/usr/sbin/vmware-guestd

, and a representative example of a recovered status summary 97 is shown in FIG. 12(e).

In order to protect the evidence on the hard drive from being destroyed or corrupted, all evidence is preferably stored on large capacity removable media. The media employed in the proof of concept prototype version is a 256M external USB 2.0 flash drive, but any other device with ample storage capacity can be used. The size of the device directly correlates to the amount of forensics evidence available for collection. For instance, USB hard drives of 1 G or larger in size can also be used to make exact mirror images of all physical memory. However, storage of this data on a USB device can be slow, and other transfer mechanisms such as firewire may be preferred. Regardless of the media type and transfer method, the same methodologies and collection techniques apply.

To prevent contamination of the hard drive it is generally recommended that the external device be mounted, and that the forensics module be stored and executed directly from it. However, in the event that it is desired to have the module itself responsible for mounting the storage device the Linux kernel provides a useful function to create new processes. An example of this is below:

static void mount_removable_media(void) {

call_usermodehelper(“/tmp/mountusb”, NULL, NULL);

}

In this case the forensics kernel module would create a new process and execute a mounting script located in the tmp directory, however it can also be used to compose a legitimate argument structure and call the mount command directly if desired.

At this point 1) all executing processes have been “frozen”, 2) the hard-drive has been forced into a “read-only” mode, and 3) extensive volatile memory evidence has been recovered from the operating system. The next step, referenced at 50 in FIG. 4(a), is to power down the machine and conduct traditional non-volatile hard drive analysis. To ease this process the final function of the module disables all interrupts and directly halts the CPU. This is accomplished with the following two inline assembly functions:

static void halt(void) {

asm(“cli”);
asm(“hlt”);

}

The machine can now be safely powered off and the uncontaminated hard drive can be imaged for additional analysis. Note that the computer must be restarted if process freezing 41 and hard-drive remounting 42 is conducted. The actual detection and collection mechanisms used within this system do not fundamentally require the restarting of the computer. Therefore, this could be used to collect volatile evidence without rebooting if there is no concern for maintaining the integrity of the hard drive.

Even though the forensics collection component has been particularly described in connection with the Linux OS, it will work on other flavors of UNIX, as well as Windows®). In addition, it can be expanded to collect forensics of network information such as connection tables and packet statistics that are stored in memory. As storage devices increase in both size and speed the system can transform itself from targeted collection to general collection with an after-the-fact analytical component. However, the requirement and technique to “freeze” processes and prevent writing to the hard drive will remain the same.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

1. A computerized method for collecting suspected data of interest from a computer that includes short-term memory and long-term memory, wherein the suspected data of interest resides within the short-term memory and is expected to be characteristic of an operating system exploit, said computerized method comprising:
(a) searching the short-term memory to locate at least one target memory range therein which contains the suspected data of interest; and
(b) copying the suspected data of interest within the target memory range to an alternate data storage location, in a manner which avoids writing the suspected data to the long-term memory.

2. A computerized method according to claim 1 wherein said alternate data storage location is external to the computer.

3. A computerized method according to claim 2 wherein said alternate data storage location has an associated long-term memory.

4. A computerized method according to claim 1 wherein said alternate data storage location is a removable, non-volatile memory media.

5. A computerized method according to claim 1 comprising preliminarily halting all unnecessary processes on the computer and remounting the computer's file system in read-only mode.

6. A computerized method according to claim 1 comprising halting the computer's CPU after the suspected data of interest has been copied.

7. A computerized method according to claim 1 whereby the suspected data of interest corresponds to one or more from a group consisting of: information associated with hidden kernel modules, re-routed system call table addresses, information within dynamic kernel memory, information associated with a running kernel image, and process information associated with each running process on the computer.

8. A computerized method according to claim 1 whereby the suspected data of interest includes information associated with each loaded kernel module, and whereby locating the target memory range comprises searching dynamic kernel memory to ascertain a corresponding memory range for each loaded kernel module.

9. A computerized method according to claim 8 comprising copying associated module data from each corresponding memory range to the alternate data storage location, thereby to obtain a respective image associated with each loaded kernel module.

10. A computerized method according to claim 1 whereby the suspected data of interest corresponds to system call table information, and whereby locating the target memory range comprises scanning the system call table to identify an address associated with each function call therein.

11. A computerized method according to claim 10 comprising copying an identification of each said address onto the alternate data storage location.

12. A computerized method according to claim 11 comprising copying to the alternate data storage location an associated range of kernel dynamic memory corresponding to each function call address which is outside of the kernel's static memory range.

13. A computerized method according to claim 1 comprising copying a running image of the computer's kernel to the alternate data storage location.

14. A computerized method according to claim 1 whereby the suspected data of interest includes process information associated with each running process on the computer.

15. A computerized method according to claim 14 for use with a computer running a Linux operating system, whereby said process information is one or more types of process-related data selected from a group consisting of: an executable image from the computer's file system corresponding to the running process, an executable image from memory for the running process, each file descriptor opened by the running process, an environment for the running process, each shared library mapping associated with the running process, command line data used to initiate the running process, and each mount point created by the running process.

16. A computerized method for collecting target forensics data from a computer that includes a volatile memory and a non-volatile memory, wherein the target forensics data resides within the volatile memory and is characteristic of a type of exploitation to the computer's operating system which renders the operating system insecure, said computerized method comprising:
(a) locating the target forensics data within the volatile memory; and
(b) copying the target forensics data from the volatile memory to an alternate data storage location in a manner which avoids utilizing memory resources associated with the non-volatile memory.

17. A computerized method for collecting suspected data of interest from a computer that includes volatile memory and non-volatile memory, wherein the suspected data of interest resides within the volatile memory and is expected to be characteristic of an operating system exploit, said computerized method comprising:
(a) locating at least one target memory range containing the suspected data of interest; and
(b) copying the suspected data of interest from the target memory range to a previously unused data storage location while preserving integrity of memory resources within the non-volatile memory.

18. A computerized method for collecting suspected data of interest from a computer that includes short-term memory and long-term memory, wherein the suspected data of interest resides within the short-term memory and is expected to be characteristic of an operating system exploitation which has rendered the computer insecure, said computerized method comprising:
(a) identifying different types of suspected data of interest, each of which is expected to be characteristic of said exploitation, thereby to establish a target data set; and
(b) for each type of suspected data of interest within the target data set:
(i) searching the short-term memory to locate an associated target memory range therein which contains the suspected data of interest; and
(ii) copying the suspected data of interest within the associated target memory range to an alternate data storage location, in a manner which avoids writing the suspected data to the long-term memory.

19. A computer-readable medium for use in collecting suspected data of interest residing within a computer's short-term memory, wherein the suspected data of interest is expected to be characteristic of an operating system exploit, said computer-readable medium having executable instructions for performing a method, comprising:
(a) locating at least one target memory range within the short-term memory which contains the suspected data of interest; and
(b) enabling the suspected data of interest to be copied from the target memory range to an alternate data storage location, in a manner which avoids writing the suspected data of interest to any long-term memory region of the computer.

20. A computer-readable medium having executable instructions for performing a method according to claim 19 wherein said alternate data storage location has associated long-term memory.

21. A computer-readable medium having executable instructions for performing a method according to claim 19 wherein said alternate data storage location is a removable storage device.

22. A computer-readable medium having executable instructions for performing a method according to claim 19 comprising preliminarily halting all unnecessary processes on the computer and remounting the computer's file system in read-only mode, and subsequently halting the computer's CPU after the suspected data of interest has been copied.

23. A computer-readable medium having executable instructions for performing a method according to claim 19 whereby the suspected data of interest corresponds to one or more from a group consisting of: information associated with hidden kernel modules, re-routed system call table addresses, information within dynamic kernel memory, information associated with a running kernel image, and process information associated with each running process on the computer.

24. A computer-readable medium having executable instructions for performing a method according to claim 19 whereby the suspected data of interest includes information associated with each loaded kernel module, and whereby locating the target memory range comprises searching dynamic kernel memory to ascertain a corresponding memory range for each loaded kernel module.

25. A computer-readable medium having executable instructions for performing a method according to claim 24 comprising copying associated module data from each corresponding memory range to the alternate data storage location, thereby to obtain a respective image associated with each loaded kernel module.

26. A computer-readable medium having executable instructions for performing a method according to claim 19 whereby the suspected data of interest corresponds to system call table information, and whereby locating the target memory range comprises scanning the system call table to identify an address associated with each function call therein.

27. A computer-readable medium having executable instructions for performing a method according to claim 26 comprising copying an identification of each said address onto the alternate data storage location.

28. A computer-readable medium having executable instructions for performing a method according to claim 26 comprising copying to the alternate data storage location an associated range of kernel dynamic memory corresponding to each function call address which is outside of the kernel's static memory range.

29. A computer-readable medium having executable instructions for performing a method according to claim 19 comprising copying a running image of the computer's kernel to the alternate data storage location.

30. A computer-readable medium having executable instructions for performing a method according to claim 19 whereby the suspected data of interest includes process information associated with each running process on the computer.

31. A computer-readable medium having executable instructions for performing a method according to claim 30 for use with a computer running a Linux operating system, whereby said process information is one or more types of process-related data selected from a group consisting of: an executable image from the computer's file system corresponding to the running process, an executable image from memory for the running process, each file descriptor opened by the running process, an environment for the running process, each shared library mapping associated with the running process, command line data used to initiate the running process, and each mount point created by the running process.

32. A system for collecting target forensics data expected to be characteristic of an operating system exploitation, comprising:
(a) a short-term memory for temporary data storage;
(b) a long-term memory for permanent data storage;
(c) a data storage location distinct from said short-term memory and said long-term memory, and
(d) a processor programmed to:
locate a target memory range within short term-memory which contains the target forensics data; and
copy the target forensics data from the target memory range to the data storage location in a manner which avoids writing said forensics data to the long-term memory.

33. A system according to claim 32 including at least one random access memory (RAM) device for accommodating said temporary data storage, and at least one hard drive adapted to accommodate both permanent data storage and needed temporary data storage.
